(19) United States
(12) Patent Application Publication
(10) Pub. No.: US 2018/0086124 A1
(43) Pub. Date: Mar. 29, 2018

(54) STAMP UNIT

(71) Applicant: SHACHIHATA INC., Nagoya-Shi (JP)

(72) Inventor: Takayuki MITSUYA, Nagoya-Shi (JP)

(73) Assignee: SHACHIHATA INC., Nagoya-Shi (JP)

(21) Appl. No.: 15/701,693

(22) Filed: Sep. 12, 2017

(30) Foreign Application Priority Data
Sep. 29, 2016 (JP) 2016-192369

(51) Int. Cl. B41K 1/40; B41K 1/02; B41K 1/50

(52) U.S. Cl. CPC B41K 1/40; B41K 1/50; B41K 1/02

(57) ABSTRACT

Provided is a stamp unit comprises a case that accommodates an ink occluding member and a frame on which an impression member formed of a porous film is tightly stretched, and a leaf spring is provided between the case and the frame. By an elastic repulsive force of the leaf spring, the impression member and the ink occluding member are constantly separated from each other, and the ink is not allowed to penetrate the impression member during distribution. In this way, even when an unexpected external force is applied to an unprocessed stamp unit, the impression member and the ink occluding member do not come into contact with each other, and penetration of ink into the impression member is prevented from starting.

### BACKGROUND OF THE INVENTION

### 1. Field of the Invention

The present invention relates to a stamp unit having an impression member corresponding to a porous film and an ink occluding member, and a stamp including the same.

### 2. Description of the Related Art

In recent years, a service has been provided to carve a sealed surface pattern designed by a customer on the spot using a thermal carving machine installed in shops where some stamps are being sold for example, thereby allowing an original stamp to be easily received and has had reputation (for example, see JP 2016-139205 A).

In this type of stamp, an impression member (stencil) is formed of a porous film. In the impression member, a sealed portion having a high ink penetration rate and a non-sealed portion having a low ink penetration rate are carved with high accuracy by a thermal head of the carving machine. An ink occluding member inside a case comes into contact with a rear surface of the impression member, whereby an ink is supplied to the impression member.

Incidentally, an unprocessed impression member being in a state where an ink is impregnated is difficult to control thermal carving, and there is concern about some defects, caused by carving it, such as contamination of a member of thermal head or films and so on. To prevent such defects, for example, U.S. Pat. No. 7,810,428 B2 and U.S. Pat. No. 8,925,454 B2 disclose a stamp in which an impression member and an ink occluding member are held at positions at which the members do not come into contact with each other, and brought into contact with each other by applying an external force to a frame of the impression member to fit the members together, and a method of manufacturing the same.

However, the stamp described in U.S. Pat. No. 7,810,428 B2 and U.S. Pat. No. 8,925,454 B2 has a configuration in which the impression member is fit to a case, therefor when an unexpected external force is applied distributing the stamp in the market for example, the impression member and the case could be fit together. As a result, penetration of the ink into the impression member starts in some cases.

### SUMMARY OF THE INVENTION

In this regard, an object of the invention is to provide a stamp unit capable of sufficiently ensuring thermal carving controllability of a sealed surface by preventing penetration of an ink into an impression member even when an unexpected external force is applied to a frame or a case, or a stamp including the same.

To solve the above-described problems, the invention is a stamp comprising a case, an ink occluding member accommodated in the case, a frame, and an impression member corresponding to a porous film tightly stretched on the frame to face the ink occluding member, characterized by further comprising an elastic member separating the impression member from the ink occluding member.

In the stamp unit having the above configuration, it is preferable that the elastic member corresponds to an elastic repulsive member that urges the impression member and the ink occluding member in a direction to constantly separate the impression member from the ink occluding member, and the elastic member corresponds to an arc-shaped leaf spring interposed between the case and the frame.

In addition, in the stamp unit having the above configuration, it is preferable that the frame is capable of being moved to a position at which the impression member and the ink occluding member come into contact with each other by compressing the elastic member.

In addition, in the stamp unit having the above configuration, it is preferable that the elastic member is compressed, when a holder is attached to the case, and the frame is held in a state in which the impression member is brought into contact with the ink occluding member.

According to the invention, a stamp unit, in which an ink occluding member is accommodated in a case and an impression member corresponding to a porous film is tightly stretched on a frame to face the ink occluding member, further comprises an elastic member that separates the impression member from the ink occluding member. Therefore, even when an unexpected external force is applied to the frame or the case, the impression member and the ink occluding member do not come into contact with each other, and penetration of ink into the impression member may be prevented. In addition, the holder and the frame cannot be in a final fit state only with the case and the frame. Further, when the holder is attached to the case, the elastic member is compressed, so that the frame may be held in a state in which the impression member is brought into contact with the ink occluding member. For this reason, it is possible to securely perform thermal carving of a sealed surface in a state in which an ink does not penetrate the impression member, and to sufficiently ensure thermal carving controllability of the impression member by eliminating a factor causing a defect at the time of a sealed surface carving.

### BRIEF DESCRIPTION OF THE DRAWINGS

FIGS. 1A and 1B are external perspective views of a stamp unit in a final fit state in which a holder and a frame are fit together according to an embodiment of the invention;

FIG. 2 is a cross-sectional view of the stamp unit in the final fit state in which the holder and the frame are fit together;

FIGS. 3A and 3B are perspective views of the frame;

FIGS. 4A and 4B are perspective views of a case;

FIG. 5A is a side view of the stamp unit when the case and the frame are fit together, and FIG. 5B is a side view of the stamp unit in the final fit state in which the holder and the frame are fit together;

FIG. 6A is a perspective view of the stamp unit when the case and the frame are fit together, and FIG. 6B is a perspective view of the stamp unit in the final fit state in which the holder and the frame are fit together;

FIG. 7 is a perspective view for description of setting of the stamp unit in the final fit state in which the holder and the frame are fit together on an attachment;

FIG. 8 is a perspective view illustrating a state in which the stamp unit in the final fit state, in which the holder and the frame are fit together, is set on a thermal carving machine; and

FIG. 9 is a perspective view for further description of setting the stamp unit in the final fit state in which the holder and the frame are fit together on the thermal carving machine.

### DETAILED DESCRIPTION OF THE PREFERRED EMBODIMENTS

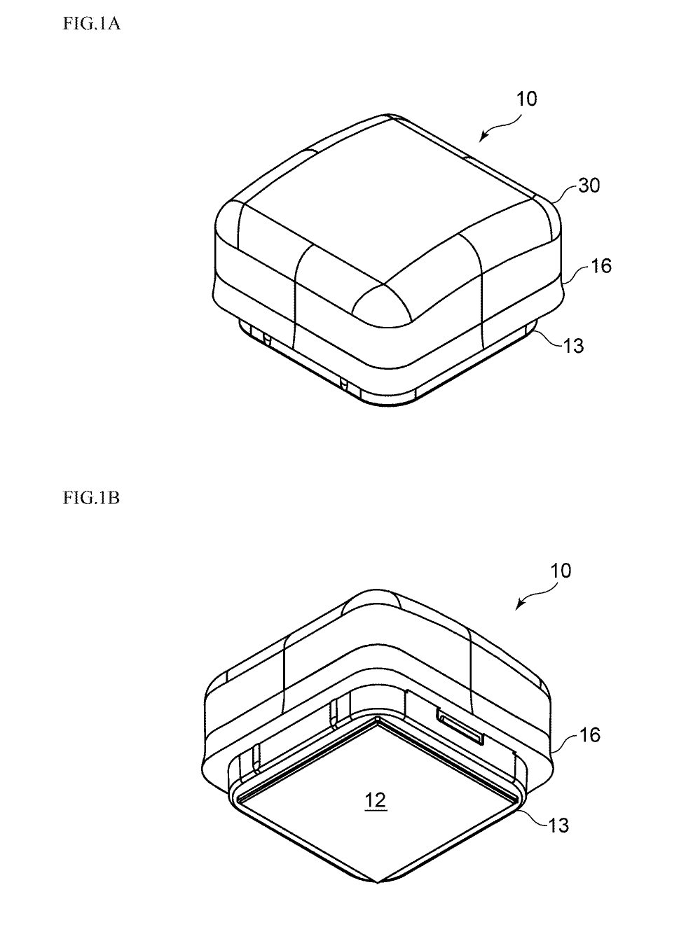

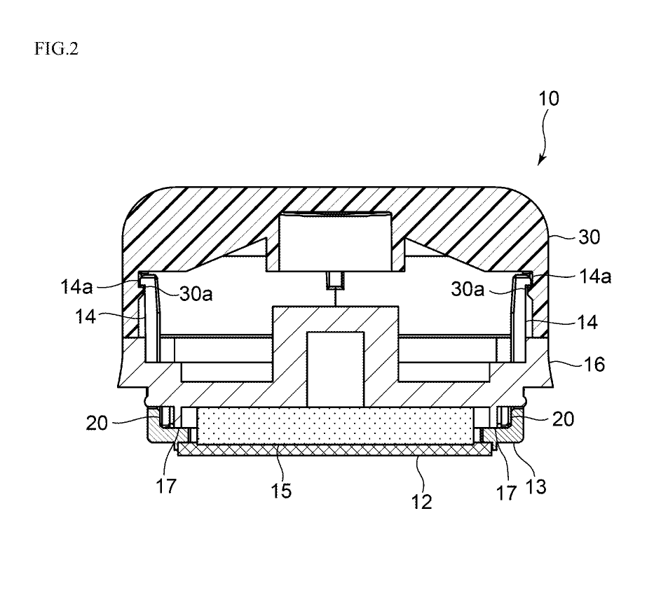

Hereinafter, a description will be given of a suitable embodiment of a stamp unit included in a porous stamp. Here, FIGS. 1A and 1B are external perspective views of a stamp unit 10 in a final fit state in which a holder 30 and a frame 13 are fit together according to an embodiment of the invention. FIG. 2 is a cross-sectional view of the stamp unit 10 in the final fit state in which the holder 30 and the frame 13 are fit together. FIG. 2 illustrates the final fit state in which the holder 30 is fit to a case 16.

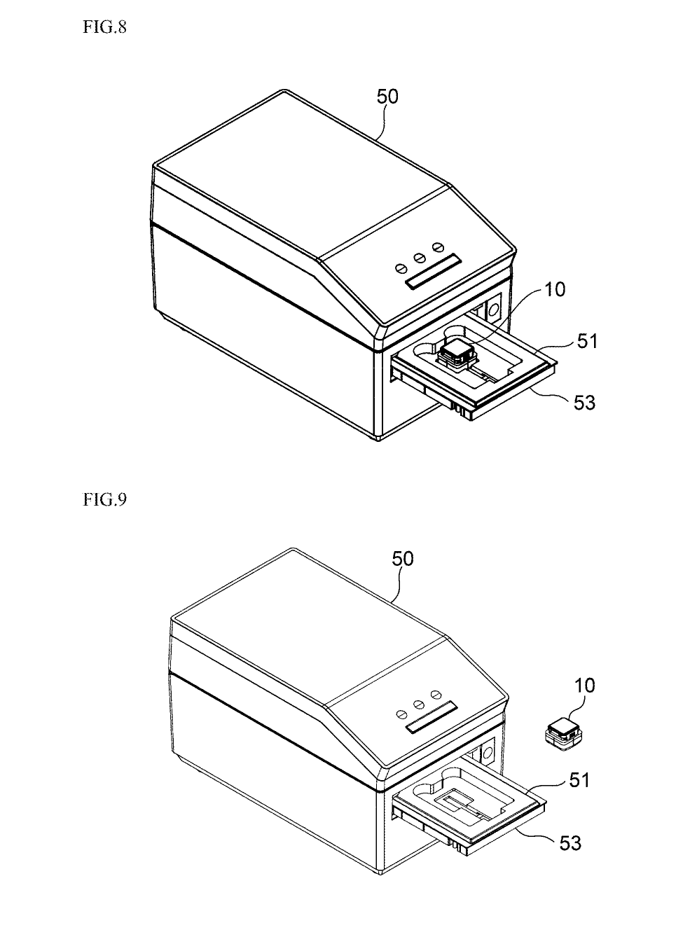

The stamp unit 10 according to the present embodiment may accurately carve a sealed surface pattern based on, for example, data of a sealed surface ordered or designed by a customer using a dedicated thermal carving machine 50 (see FIG. 8 and FIG. 9) installed in shops where some stamps are being sold. For that purpose, the stamp unit 10 includes an impression member 12 formed of a porous film and an ink occluding member 15 coming into contact with a rear surface of the impression member 12 to supply an ink by allowing the ink to penetrate therethrough. A sealed portion having a high ink penetration rate and a non-sealed portion having a low ink penetration rate are carved in the impression member 12 corresponding to the porous film by controlling driving of a thermal head of the carving machine 50 described below. In this way, a highly accurate sealed surface pattern is formed.

The porous film corresponding to the impression member 12 is not particularly limited when the porous film corresponds to a porous material whose surface may be heated and melted by the thermal head and solidified. For example, styrene-based, vinyl chloride-based, olefin-based, polyester-based, polyamide-based, and urethane-based thermoplastic elastomers, etc. may be used as a raw material of the porous material. To obtain porosity, a filler such as starch, sodium chloride, sodium nitrate, calcium carbonate, etc. and a raw material resin are kneaded using a heating/pressurizing kneader, a heating roller, etc., to form a sheet, and then cooled. Then, the filler is eluted using water or a dilute acid. A melting temperature of the porous material manufacturing by this method is the same as that of the raw material resin. In addition, the melting temperature of the porous material may be adjusted by adding a minor component such as a pigment, a dye, an inorganic substance, etc. to the resin. The melting temperature of the porous material according to the present embodiment is in a range of 70° C. to 120° C.

Porosity and a pore diameter of the porous film corresponding to the impression member may be adjusted by a particle diameter of a dissolved substance to be kneaded and content thereof. The porosity of the porous film according to the present embodiment is in a range of 50% to 80%, and the pore diameter is in a range of 1 μm to 20 μm. The porous film may have a two-layer structure and the porosity on the ink occluding member 15 side may be in a range of 50 μm to 100 μm.

The stamp unit 10 according to the present embodiment includes the frame 13 that provides the impression member 12 described above and the case 16 that accommodates the ink occluding member 15.

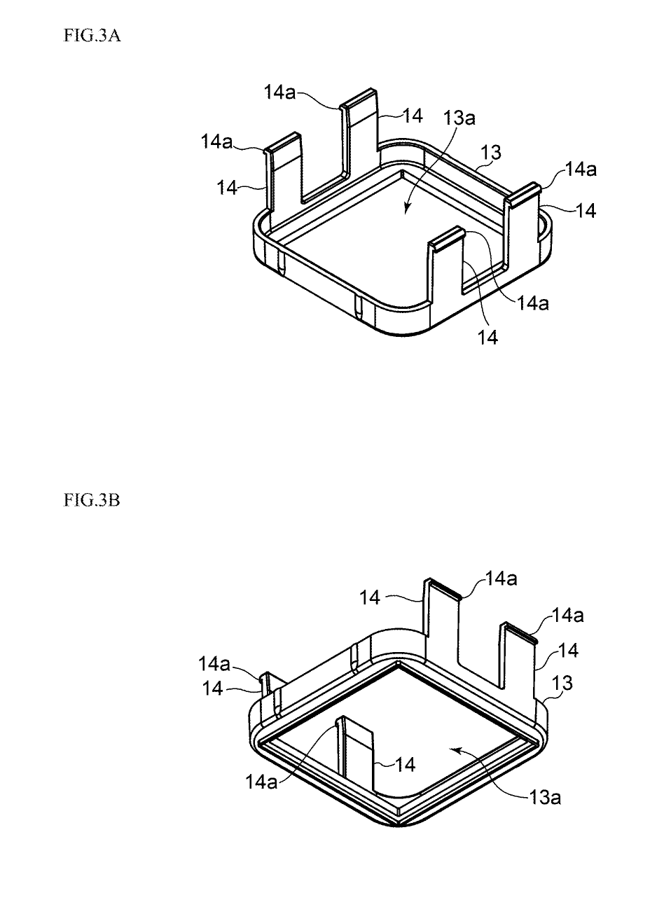

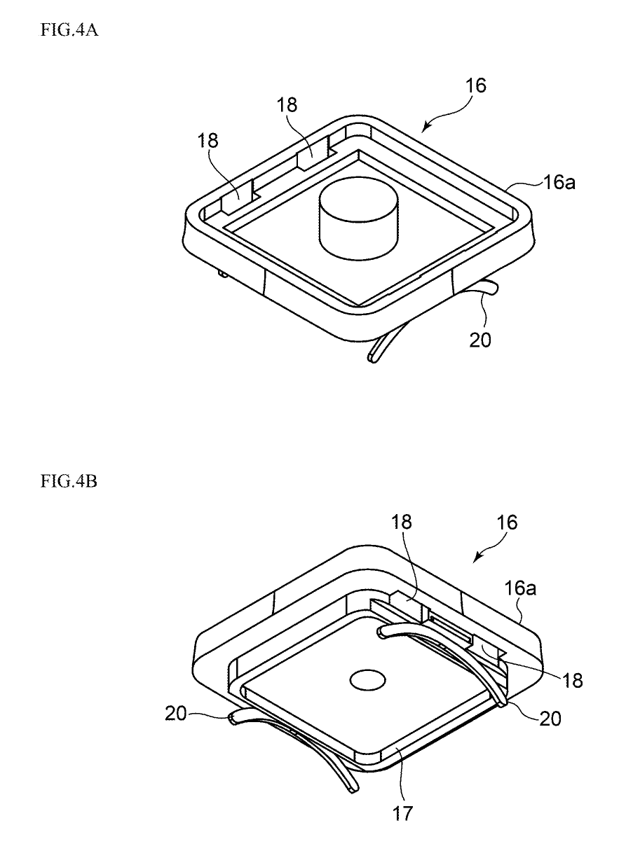

FIGS. 3A and 3B illustrate perspective views of the frame 13. For example, the frame 13 is a member integrally molded using resin. As illustrated in FIG. 1A, the impression member 12 formed of the porous film is tightly stretched to close an aperture 13a of the frame 13 having a substantially rectangular shape. For example, an outer edge of the impression member 12 is attached to a front surface of an aperture end of the frame 13, and preferably fused thereto. In addition, for example, four engagement legs 14 engaged with the holder 30 described below are formed integrally with the frame 13 by extending to an opposite side from the sealed surface.

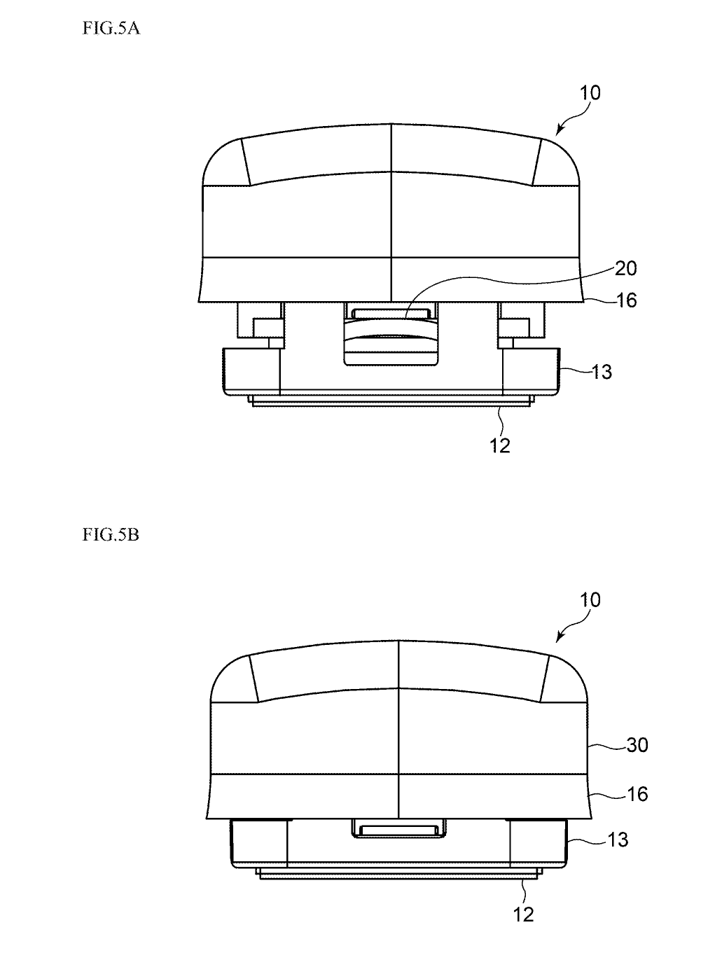

FIGS. 4A and 4B illustrate perspective views of the case 16. The case 16 is made of a roughly thick plate-shaped resin member including a flange 16a whose external shape has substantially the same shape and the same size as those of the above-described frame 13. As illustrated in the cross-sectional view of FIG. 2, the ink occluding member 15 is surface-bonded to a center surrounded by a wall 17 on an inside of the flange 16a. Further, holes 18 for passing the engagement legs 14 of the frame 13 described above are formed at four positions by penetrating therethrough around a boundary between the wall 17 and the flange 16a.

For example, resilient foam or nonwoven fabric such as polyethylene, polypropylene, polyethylene terephthalate, polyurethane, acrylonitrile butadiene rubber, etc. may be used as a material of the ink occluding member 15.

In the ink occluding member 15, ink penetration efficiency with respect to the impression member 12 is prone to decrease since, for example, viscosity of the ink increases over time. For this reason, the ink occluding member 15 is preferably formed in two layers having different basis weights. For example, when the ink occluding member is formed of a polyolefin-based fiber (PP PE), a basis weight of a first layer on the case 16 side is preferably set to 0.1 to 0.15 g/cm², and a basis weight of a second layer on the impression member 12 side is preferably set to 0.2 to 0.3 g/cm². In other words, it is possible to create a flow of ink due to a difference in capillary force by increasing density on the impression member 12 side. In this way, it is possible to stably shorten a time during which ink penetrates into the porous film (the impression member 12).

When the ink occluding member 15 has two layers, it is preferable to attach the first layer and the second layer to each other by thermal fusion. Alternatively, the two layers may be partially attached using an adhesive. Alternatively, it is possible to perform processing such as providing unevenness on bonding surfaces of the respective layers without attaching the layers, thereby preventing positional deviation.

The stamp unit 10 is a product which is distributed in the market and is provided to the customer in a state in which the frame 13 having the impression member 12 is fit to the case 16 accommodating the ink occluding member 15 impregnated with ink in advance. However, when the ink occluding member 15 and the impression member 12 come into contact with each other, for example, due to some unexpected external force before the stamp unit 10 is provided to the customer, there is concern that ink may start to penetrate into the impression member 12 from the ink occluding member 15, thereby causing a defect at the time of carving the sealed surface. For this reason, the stamp unit 10 of the present embodiment includes a repulsive elastic member which prevents unexpected contact between the impression member 12 and the ink occluding member 15 and constantly exerts an urging force in a direction to separate the members even when the members come into contact with each other. Here, when the holder 30 is fit to the case 16 in advance, there is a possibility that a notch 30a and a hook portion 14a will fit together when an unexpected external force is applied, and penetration of ink into the impression member 12 may start. Thus, the holder 30 and the case 16 are preferably separate bodies.

For example, such a repulsive elastic member may correspond to an arc-shaped leaf spring 20 illustrated in FIGS. 4A and 4B which is interposed between the case 16 and the frame 13. The frame 13 may be moved to a position at which the ink occluding member 15 and the impression member 12 come into contact with each other by compressing the leaf spring 20.

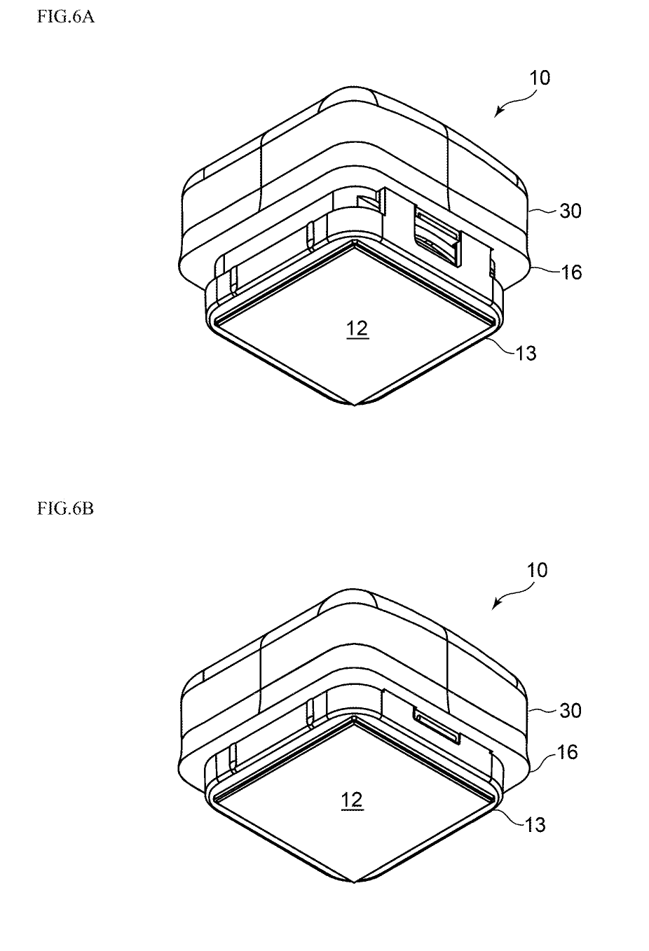

The stamp unit 10 according to the present embodiment has a structure assembled by finally fitting the holder 30 to the frame 13. Here, FIG. 5A and FIG. 6A illustrate a perspective view and a side view of a state in which the case 16 and the frame 13 are fit together (at the time of distribution). FIG. 5B and FIG. 6B illustrate a perspective view and a side view of a final fit state in which the holder 30 and the frame 13 are fit together (at the time of use).

In the state in which the case 16 and the frame 13 are merely fit together as illustrated in FIG. 5A and FIG. 6A, an elastic repulsive force of the leaf spring 20 acts between the case 16 and the frame 13, and the ink occluding member 15 and the impression member 12 are not in contact with each other.

When the frame 13 is pushed to the case 16 side against the elastic repulsive force of the leaf spring 20 from the state in which the case 16 and the frame 13 are fit together, it is possible to obtain the final fit state in which the holder 30 and the frame 13 are fit together as illustrated in FIG. 5B and FIG. 6B. In this final fit state, as illustrated in FIG. 2, the hook portion 14a at a distal end of the engagement leg 14 extending from the frame 13 is engaged with the notch 30a inside the holder 30. In this instance, the impression member 12 comes into contact with the ink occluding member 15, and penetration of ink may be started. In addition, the elastic repulsive force of the compressed leaf spring 20 acts in a direction of pulling the holder 30 to the case 16 side by the hook portion 14a of the frame 13. For this reason, when the holder 30 is temporarily brought into the final fit state in which the holder 30 is fit to the frame 13, the case 16 and the impression member 12 are not irreversibly disengaged.

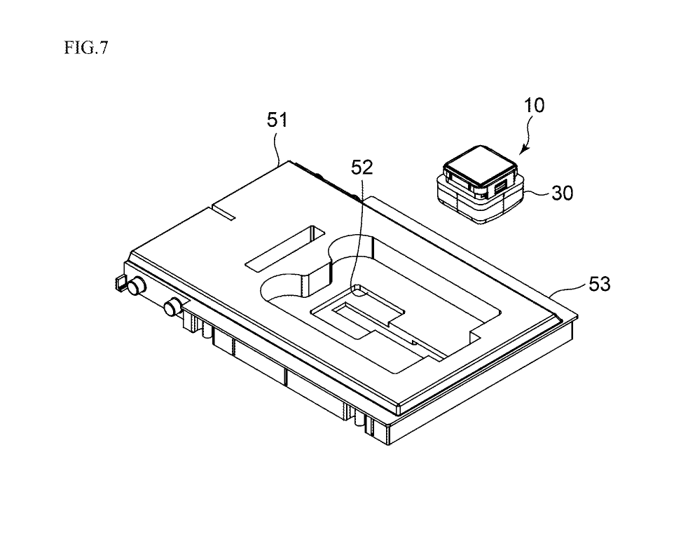

A description will be given of a procedure of carving the sealed surface using the thermal carving machine 50 on the stamp unit 10 configured as described above. As illustrated in FIG. 7, the stamp unit 10 being in the final fit state in which the holder 30 and the frame 13 are fit together is securely set by being fit into an accommodation portion 52 of an attachment 51. The attachment 51 is a rectangular plate-shaped member and has a structure that allows the attachment 51 to be accommodated in a tray 53 of the thermal carving machine 50.

Subsequently, as illustrated in FIG. 8, when the attachment 51 is accommodated in the tray 53 of the thermal carving machine 50, a sealed surface is formed thereafter on the impression member 12 by the thermal head according to a program instruction in the thermal carving machine 50. In sealed surface carving by the thermal head, a sealed surface pattern is created with high accuracy based on input data.

As illustrated in FIG. 9, carving may be performed after setting the stamp unit 10 in the final fit state in which the holder 30 and the frame 13 are fit together in the attachment 51 accommodated in the thermal carving machine 50 in advance.

Then, after carving of the sealing surface is finished, the stamp unit 10 in the final fit state in which the holder 30 and the frame 13 are fit together may be taken out by pulling out the attachment 51 from the thermal carving machine 50.

According to the stamp unit 10 of the embodiment described above, the impression member 12 and the ink occluding member 15 may be separated by a deformation distance of the elastic member by providing the elastic member between the case 16 and the frame 13. Therefore, even when an unexpected external force is applied to the unprocessed stamp unit 10, the impression member 12 and the ink occluding member 15 do not come into contact with each other, so that penetration of ink into the impression member 12 may be prevented. In this way, it is possible to eliminate a factor causing a defect at the time of sealed surface carving, and to sufficiently ensure thermal carving controllability of the sealed surface.

In addition, by setting the elastic member to an elastic repulsive member urging the ink occluding member 15 and the impression member 12 to a direction to constantly separate the members from each other, and preferably to the arc-shaped leaf spring 20, even when the ink occluding member 15 and the impression member 12 come into contact with each other due to a stronger force than an elastic repulsive force temporarily acting thereon, the members may be pushed back by a repulsive force thereof. Thus, penetration of ink into the impression member 12 may be more securely prevented from starting.

What is claimed is:

1. A stamp unit comprising:
a case;
an ink occluding member accommodated in the case;
a frame; and
an impression member corresponding to a porous film tightly stretched on the frame to face the ink occluding member,
characterized by further comprising an elastic member separating the impression member from the ink occluding member.

2. The stamp unit according to claim 1, wherein the elastic member corresponds to an elastic repulsive member that urges the impression member and the ink occluding member in a direction to constantly separate the impression member from the ink occluding member.

3. The stamp unit according to claim 1, wherein the elastic member corresponds to an arc-shaped leaf spring interposed between the case and the frame.

4. The stamp unit according to claim 1, wherein the frame is capable of being moved to a position at which the impression member and the ink occluding member come into contact with each other by compressing the elastic member.

5. The stamp unit according to claim 1, wherein the elastic member is compressed, when a holder is attached to the case, and the frame is held in a state in which the impression member is brought into contact with the ink occluding member.
